(19) United States
(12) Patent Application Publication
(10) Pub. No.: US 2025/0276402 A1
(43) Pub. Date: Sep. 4, 2025

(54) METHOD AND APPARATUS FOR WELDING A SINGULATED MULTILAYER PRODUCT

(71) Applicant: HERRMANN ULTRASCHALLTECHNIK GMBH & CO. KG, Karlsbad (DE)

(72) Inventors: Andreas RUNCK, Karlsruhe (DE); Julian DEEG, Keltern (DE); Philipp PETMECKY, Karlsruhe (DE); Hermann DEJAGER, Marienheide (DE); Jürgen BEINGHAUS, Wipperfürth (DE)

(21) Appl. No.: 18/985,933

(22) Filed: Dec. 18, 2024

(30) Foreign Application Priority Data
Dec. 21, 2023 (DE) 102023136343.3

(51) Int. Cl. B23K 20/10; B23K 103/16

(52) U.S. Cl. CPC B23K 20/10; B23K 2103/166

(57) ABSTRACT

Process and apparatus for welding a singulated, multi-layer product.

### FIELD OF THE INVENTION

The present invention relates to a process and a device for welding a singulated, multi-layer product.

### BACKGROUND OF THE INVENTION

Ultrasonic welding has proven to be a very advantageous process in many areas of product manufacturing. Two main areas of ultrasonic welding are continuous processes, in which, for example, multi-layer webs of material are continuously welded, and discontinuous processes, in which, for example, two components of an assembly are repeatedly joined together by a person working on a piecework basis. A continuous process is known from DE 10 2014 110 634 A1.

In the field of production technology, there are still joining processes that cannot yet be implemented using ultrasonic welding, for example the continuous welding of singulated containers, in particular bags. In the case of welding, a singulated, still open container is closed by means of a weld seam. The container has usually been filled beforehand, for example with food, animal feed or care products. The weld seam welds together several layers of the container, usually two walls delimiting the container. In the case of sealing welding, it is of considerable importance that the weld seam seals the container airtight in order to protect the contents from the ambient air.

DE 10 2013 100 474 A1 relates to an ultrasonic welding device for sealing singulated products, in particular the gable seam of a milk carton. DE 10 2015 110 387 A1 discloses an ultrasonic welding device that can also be used to weld individual composite packages. U.S. Pat. No. 3,294,616 shows an ultrasonic welding device in which a minimum gap is set by means of a stop. Two processes for intermittent ultrasonic processing of a material web are known from DE 10 2017 107 617 A1 and DE 10 2022 105 944 A1.

The ultrasonic welding processes known from the prior art are not satisfactorily suited for the continuous sealing of singulated containers/packaging. In earlier attempts at continuous ultrasonic welding, the container was damaged, especially at its edges, or the weld seam was not sealed by the welding process, which is unacceptable.

Discontinuous processes can be considered for the sealing welding of separated bags. However, they often take longer and can only be incorporated into production processes involving flow production with a great deal of effort.

### SUMMARY OF THE INVENTION

The problem to be solved by the invention was therefore to provide a way of sealing singulated products quickly and reliably in a continuous process.

This problem is solved by the process and device according to the invention.

In the process for welding a singulated, multi-layer product by means of an ultrasonic tool, which comprises a generator, an anvil and a vibrating structure with a converter, a sonotrode and optionally a transformation piece (amplitude amplifier), the product is moved through a gap formed between the sonotrode and anvil with a gap width S. The (singulated) product is welded during its movement by the ultrasonic tool along a welding path, in that the sonotrode and/or anvil are pressed against the product with a force and the sonotrode is excited by the generator in such a way that it oscillates with a predetermined amplitude and transfers the vibration to the product. At least one welding parameter, preferably the amplitude and/or the force and/or the gap width, is regulated and varied during the movement of the product.

Other welding parameters can also be controlled without being varied. They can then be set to a constant target value, for example.

When welding singulated products, the situation in the gap is not always the same, as is the case, for example, in the continuous welding of material webs. At some times there is a product in the gap, at other times there is not. The edge areas of the singulated products, i.e. the transition between the situations with a product in the gap and without, are a particular challenge. By varying one of the welding parameters, the welding can be adapted to the situation currently present in the gap and the transition bridged. For example, a reduced amplitude in the edge areas of the product means that less welding energy is applied, thus preventing damage to the edges. It is therefore advantageous for the welding path to begin in a first edge area of the product and/or to end in a second edge area of the product. This avoids damaging the edges.

The amplitude is a common process variable. A given amplitude is understood to be a target value that can be entered, for example, on the ultrasonic tool.

The process according to the invention is, in particular, a process for welding a plurality of singulated, multi-layer products. In this case, a plurality of products are moved one after the other through the gap and each product is welded during its movement by the ultrasonic tool along a welding path, wherein the products are, in particular, spaced apart from one another.

One application for the process is the sealing of bags or similar packaging. Such bags usually consist of at least two layers of material, which are usually the same size and are placed on top of each other. The layers are then joined together at three edges (left, right and bottom) by material bond, often by heat sealing. Other types of connection, such as ultrasonic welding, are also possible. The open bag produced in this way can then be filled with contents. The opening of the bag must then be sealed to protect the contents from environmental influences. The heat-sealed edge areas form a hard edge. Ultrasonic tools experience a strong impulse at this edge, which has led to damage in the edge areas in tests with constant welding parameters. The process according to the invention is particularly suitable for sealing welding, since an adaptation to the layers previously joined by material bonding is also possible by varying the welding parameters. In advantageous further developments, the products are therefore sealed with a material bond in at least one of the edge areas before they are moved through the gap. The width of the edge areas is preferably 5-8 mm. The product of the process is therefore preferably a bag, in particular an open-top bag and/or a bag filled with contents.

The welding energy introduced into the product is significantly influenced by the amplitude. Therefore, it has proven to be particularly advantageous to vary the amplitude. Advantageously, the sonotrode is therefore excited for welding the product in such a way that it oscillates with an amplitude A_{high}, wherein A_{high} is preferably between 20 μm and 40 μm, and the sonotrode excited at other times such that it oscillates with an amplitude A_{low}, which is smaller than A_{high}, wherein the following preferably applies: 0<A_{low} and/or A_{low}<0.5*A_{high}. The low amplitude A_{low} is used in particular when no product is arranged in the gap. The reduction of the amplitude reduces the impulse that the ultrasonic tool experiences when the edge of the products is moved into the gap. As a result, the edge area suffers less damage. Below 0.5*A_{high}, almost no welding effect is achieved, but this is not necessary in the edge area, since the layers are already connected to one another by material bond. The amplitude is preferably not lowered to 0 so that the increase to A_{high} takes less time. This allows the speed at which the products are moved through the gap to be increased and/or the distance between the products to be reduced. This speeds up the manufacturing process as a whole. Below 20 μm, the welding is insufficient, and above 40 μm, the welding can be damaged and cause leakage. The preferred distance between products is 10 mm to 250 mm, especially 30 mm to 180 mm.

The welding parameter of the ultrasonic tool is preferably controlled depending on the movement or position of the product. In particular, the amplitude is set to A_{high} when the product arrives at or before the gap and/or the amplitude is set to A_{low} when the product leaves the gap. This ensures that the actual welding process takes place via the desired welding path. In the case of heat-sealing bags, a tight and firm seal could be achieved without damaging the edges.

The variation of the welding parameter can be carried out depending on different mechanisms. The variation can be carried out depending on time, i.e. it is time-controlled. In this case, a program can be stored in the generator control that varies the welding parameter over time. If the speed of the products is known, then such a control can suffice. The speed of the products can also be an input variable for the variation of the welding parameters. In order to achieve a more precise adjustment of the welding parameter, it is envisaged that the position of the product to be welded is detected at least once if further developments are advantageous. In this way, a sensor unit can be used to detect whether the product arrives at the gap or leaves the gap. The welding parameter can then be adjusted accordingly. Preferably, the sensor unit sends a signal directly to the generator and the generator sets the amplitude to A_{high} or A_{low}, optionally with a time delay. The direct connection between the sensor unit and the generator avoids a loss of time due to signal processing in a control unit. The signal is preferably a binary signal, which saves time when the generator processes it. If the sensor unit or the point at which the product is detected is at a distance from the gap, the time delay can be used to compensate for the time that the product still needs to arrive at the gap.

In order to avoid damage to the product and the ultrasonic tool, there is a transition from a current amplitude A_{now} to a target amplitude, in particular A_{high} or A_{low}, preferably by continuously adjusting (ramping) the amplitude, wherein a slope of the ramp is preferably controlled continuously and/or wherein the ramp lies within one of the edge regions or overlaps one of the edge regions. The same also preferably applies to other welding parameters.

At different times during the course of the process according to the invention, a product may be located in the gap or the gap may be free. In order that in the latter case the next incoming product can enter the gap and at the same time immediate processing of the product is possible, the gap width S of the gap is preferably set continuously by moving the sonotrode and/or anvil relative to one another, wherein preferably a metal contact detection and/or a distance measurement is used as an input variable for controlling the size of the gap and/or a target size for the gap is set and used as an input variable for controlling the gap width S. In continuous welding processes, for example of material webs, controlling the gap width is not useful, since there is always material between the sonotrode and anvil anyway. The gap width S is preferably the shortest distance between the anvil and the sonotrode.

As mentioned above, the product is preferably filled with contents before it is moved through the gap and welded. This avoids subsequent work steps and the process according to the invention can represent the last work step in the production of a filled product.

The economic efficiency of the process depends largely on the speed of the products. The speed can also affect the quality of the weld. At the same time, it must be ensured that the products are welded evenly and securely. The product is preferably moved through the gap at a speed of 5 m/min to 100 m/min. At speeds below 5 m/min, not enough products are produced per unit of time, while at speeds above 100 m/min, defects may occur in the welding.

In addition to the speed, the number and thickness of the layers of the product also influence the quality of the weld. The product should preferably comprise at least two layers, with a layer thickness of between 50 μm and 300 μm each. If the layer thickness is below 50 μm, the welding energy applied may be too high, resulting in damage to the layers and an insufficiently sealed weld. If the layer thickness is above 300 μm, the welding energy applied may be too low, also resulting in an insufficiently sealed weld.

The device according to the invention for welding a singulated, multi-layer product has an ultrasonic tool and a conveying device. The ultrasonic tool comprises a generator, a converter, a sonotrode and an anvil, wherein a gap with a gap width S is formed between the sonotrode and the anvil, wherein the generator is set up to excite the sonotrode in such a way that it oscillates with an amplitude and wherein the ultrasonic tool is set up to press the sonotrode and/or anvil against the product with a force. At least one welding parameter of the ultrasonic tool, preferably the amplitude and/or the force and/or the gap width, can be adjusted and varied. The conveying device is set up to move the singulated product through the gap, preferably to move it in such a way that the product is welded along a welding path by the ultrasonic tool during its movement, in that the sonotrode is excited by the generator in such a way that it oscillates with a predetermined amplitude and transfers the vibration to the product.

The converter and the sonotrode form an oscillating unit of the ultrasonic tool. The oscillating unit can also include an amplitude amplifier.

The ultrasonic tool, in particular the generator, and the conveying device are preferably connected to a common control device.

As described above, detection of the product is advantageous for the welding. Therefore, preferably, the device also includes a sensor unit that is set up to detect whether the product arrives at or before the gap or whether the product leaves the gap. The desired welding parameter can then be varied depending on the sensor signal. The sensor unit is preferably connected directly to the generator. This avoids a time delay caused by an intermediate control. In this case, the generator is set up to vary the welding parameter, in particular the amplitude, in response to a signal from the sensor unit. The amplitude can be varied, for example, by changing the frequency with which the generator excites the converter.

In advantageous further developments, the sensor unit comprises at least one sensor, preferably an optical sensor and/or a capacitive sensor, which is aligned in such a way that the product is moved into a detection range of the sensor and/or out of a detection range of the sensor when it arrives at or before the gap and/or when it leaves the gap. In this way, arrival at the gap or departure from the gap can be reliably detected. The sensor may, for example, be an optical reflection switch.

The conveying device preferably includes movable grippers that are set up to grip one or more products each. Furthermore, the conveying device preferably includes a continuous conveyor, in particular a conveyor belt, by means of which the grippers can be moved. Particularly preferably, the conveying device is a linear axis system with grippers.

In advantageous further developments, the sonotrode and/or the anvil have an at least partially circular outer contour and are rotatably mounted. The circular outer contour represents a physical ramp for a product arriving at the gap. This serves to cushion the momentum that arises when the product arrives at the gap. The rotatability also serves to reduce the momentum, since the sonotrode or anvil can move along with the product. Preferably, the rotating part is even actively rotated, in particular in such a way that it moves along with the product.

As described above, the gap width S is preferably controlled. In the device, the sonotrode and/or the anvil are therefore preferably displaceable relative to one another. Preferably, a gap control device between the sonotrode and anvil is electrically connected to a metal contact detection device. Alternatively or additionally, a sensor for detecting a distance between the sonotrode and anvil is possible. The gap width S can be adjusted by means of the displaceability. The distance sensor provides an input signal for controlling the gap width S. Alternatively, the gap width S can be set to a fixed value. The device is then less complex overall.

### BRIEF DESCRIPTION OF THE DRAWINGS

The invention is explained and illustrated by means of the drawings as examples.

FIG. 1 shows an embodiment of a device for welding a singulated, multi-layer product in a front view,

FIG. 1x shows detail X of FIG. 1,

FIG. 2 shows the device according to FIG. 1 in a top view and

FIG. 3 schematically shows the welding of a product.

### DETAILED DESCRIPTION OF THE INVENTION

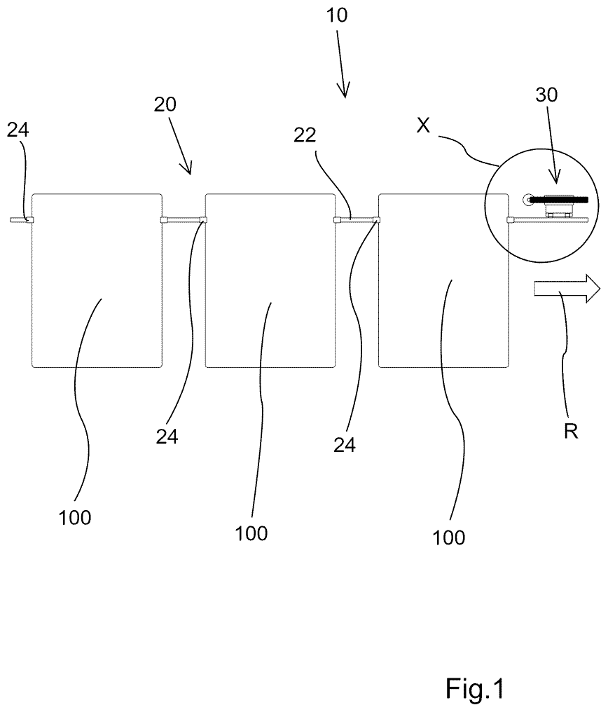

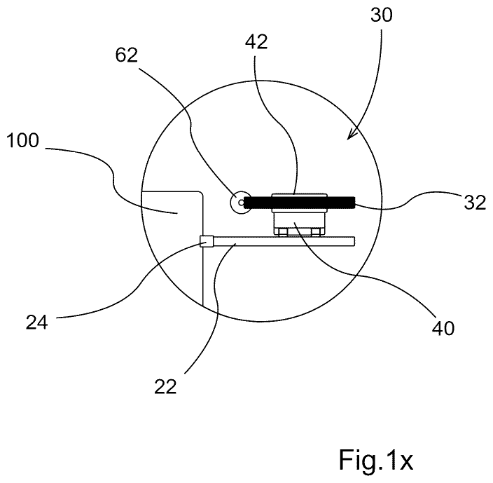

The device 10 shown in FIG. 1 has a conveying device 20 and an ultrasonic tool 30. In this embodiment, the conveying device 20 comprises a conveyor belt 22 with gripping elements 24. The gripping elements 24 can be moved in a conveying direction R by means of the conveyor belt 22. The conveyor belt 22 moves at a constant speed. The gripping elements 24 are designed to grip individual products 100, in this case bags. In this way, the products 100 are moved continuously and at the same speed in the conveying direction R. The gripping elements 24 are spaced apart from one another, so that the products 100 are also transported at a distance from one another.

In the case of the products 100, the embodiment shown here involves multi-layer bags that are open at the top and filled with contents. The bags are only shown schematically.

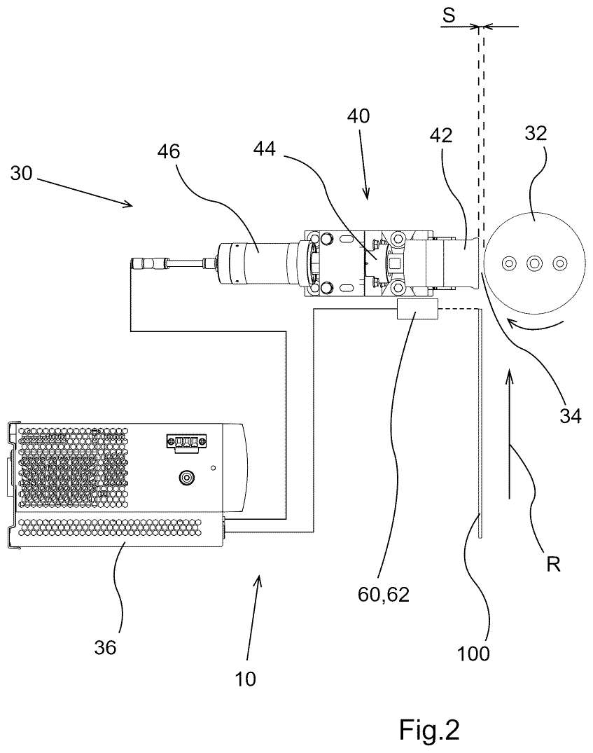

The ultrasonic tool 30 is shown in more detail in FIGS. 1x and 2. It includes a generator 36, an anvil 32 and a vibration unit 40 with a sonotrode 42, an amplitude amplifier 44 and a converter 46. The anvil 32 is rotatably mounted and is actively rotated. The converter 46 is supplied with a voltage by the generator 36. The vibration unit 40 is designed in such a way that it vibrates in resonance when the converter 46 is excited by the generator 36 with a voltage of a predefined frequency. The sonotrode 42 vibrates with an amplitude that depends, among other things, on the excitation frequency. The amplitude is measured in particular along the main axis of the vibration unit 40. The generator 36 is set up to excite the sonotrode 42 or the vibration unit 40 with different amplitudes, in particular a high amplitude A_{high} and a low amplitude A_{low}.

Sonotrode 42 and anvil 32 form a gap 34 between them, which has a gap width S. The gap width S is preferably the shortest distance between anvil 32 and sonotrode 42. In the embodiment shown, the low amplitude A_{low} is 30% of the high amplitude A_{high} (A_{low}=0.3·A_{high}). With the low amplitude A_{low}, there is no or almost no welding when a bag is in the gap 34. The high amplitude A_{high}, on the other hand, causes the layers of the bag to be welded at the points where the bag abuts between the anvil 32 and the sonotrode 42.

The gap control device between the sonotrode 42 and anvil 32 is connected to a metal contact detector. A control that can be used for this is known, for example, from EP 0 790 888 B1. The metal contact detector is used to continuously control the gap width S. At the same time, a force is applied to the sonotrode 42 and anvil 32, causing a force to be exerted on the products 100 when they are in the gap 34.

The products 100 are moved in the conveying direction R by the conveying device 20 (not shown in FIG. 2) as described above. As a result, the products 100 enter the gap 34 one after the other, pass through it and then leave the gap 34 again. If the vibration unit 40 is activated during the movement, the layers of the respective product 100 are welded together when it is in the gap 34. The bags are closed at the top in this way.

The device 10 also includes a sensor unit 60 with a sensor 62. The sensor 62 has a detection range into which the products 100 are moved when they arrive in front of the gap 34, that is to say before the respective product 100 is in the gap 34. This state is shown in FIG. 2. If there is no product 100 in the gap, the generator excites the vibration unit 40 in such a way that the sonotrode 42 vibrates with the low amplitude A_{low}.

The sensor 62 is arranged at a distance from the gap 34, wherein the distance is known. Since the speed of the bags is also known, the time that elapses between detection and entry of the bag into the gap can be calculated from this (time=distance/speed). The sensor 62 transmits a detection signal directly to the generator 36 of the ultrasonic tool 30. After a preset time delay, the generator 36 excites the vibration unit 40 of the sonotrode 42 in such a way that it vibrates at a high amplitude A_{high}. The time delay is selected depending on the distance of the sensor 62 from the gap 34 and the speed of the bags (see above).

The distance between the sensor 62 and the end of the gap 34 is also known. In combination with the speed of the products 100, it is therefore also possible to determine when a detected product 100 leaves the gap 34. After a further time delay, the generator 36 therefore again stimulates the vibration unit 40 in such a way that it vibrates at the low amplitude A_{low}. Alternatively, the changeover to A_{low} can also be triggered by the sensor 62 no longer detecting the product 100. Here, too, a predetermined time delay can be provided.

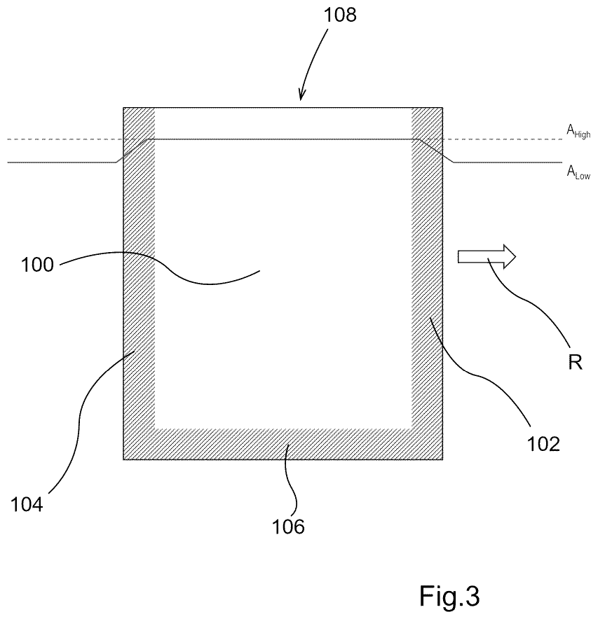

The transition from A_{high} to A_{low} and vice versa does not occur abruptly, but rather steadily and evenly. This transition is shown schematically in FIG. 3. The product to be welded, 100, is, as mentioned above, a bag that is open at the upper end, 108. The bag is already closed with a material bond at its edge areas 102, 104 and at the bottom 106. Therefore, the bag can be filled with contents before it is closed. The conveying direction R is also shown here.

The change in the amplitude of the sonotrode 42 during the movement of the bag is also shown schematically in FIG. 3. In the initial state, the sonotrode 42 oscillates at the low amplitude A_{low}. The edge area 102 of the bag first encounters the ultrasonic tool 30. The sensor 62 detects beforehand, as described above, that the product 100 is approaching the gap 34. Thereupon, the amplitude of the sonotrode 42 is set to the high amplitude A_{high}. The transition from A_{low} to A_{high} occurs along a ramp, i.e. it is continuous and even. The increase in amplitude begins shortly before the edge area 102 enters the gap 34. The high amplitude A_{high} is reached before the edge area 102 is fully positioned in the gap 34. The ramp thus overlaps with the edge area 102.

When the second edge area 104 leaves the gap 34, the amplitude of the sonotrode 42 is reduced along a ramp to the low amplitude A_{low}. The start of the reduction occurs shortly after the edge area 104 has left the gap 34. The reduction ends shortly after the edge area 104 has completely left the gap 34.

The targeted increase and decrease of the amplitude ensures that the desired welding is carried out completely with the high amplitude A_{high}. The path along which the bag was welded is referred to as the welding path. In the embodiment shown, the welding path thus begins in edge region 102 and ends in edge region 104. This approach has proven effective in terms of the quality of the processing, particularly at the edges of the bag. The welding begins and ends, so to speak, in the edge regions 102, 104, whereby the edges of the bag remain largely in their preceding state. The previously open area of the bag is securely closed in this way and the edges remain largely unaffected.

### LIST OF REFERENCE SIGNS

10 device
20 conveying device
22 conveyor belt
24 gripping elements
30 ultrasonic tool
32 anvil
34 gap
36 generator
40 vibration unit
42 sonotrode
44 amplitude amplifier
46 converter
60 sensor unit
62 sensor
100 product
102 edge area
104 edge area
106 bottom
108 upper end
R conveying direction
S gap width

What is claimed is:

1. A process for welding a singulated, multi-layer product by means of an ultrasonic tool, which comprises a generator, a sonotrode and an anvil,
wherein the product is moved through a gap formed between the sonotrode and the anvil, with a gap width S,
wherein the product is welded during its movement by the ultrasonic tool along a welding path by pressing the sonotrode and/or anvil against the product with a force and exciting the sonotrode by the generator in such a way that it oscillates with a predetermined amplitude and transmits the vibration to the product,
wherein at least one welding parameter, preferably the amplitude and/or the force and/or the gap width, is regulated and varied during the movement of the product.

2. The process according to claim 1, wherein the welding path begins in a first edge region of the product and/or ends in a second edge region of the product, the products preferably being closed in material bond in at least one of the edge regions before they are moved through the gap.

3. The process according to claim 1, wherein the sonotrode for welding the product is excited such that it oscillates with an amplitude A_{high}, wherein A_{high} is preferably between 20 μm and 40 μm, and the sonotrode is excited at other times such that it oscillates with an amplitude A_{low}, which is smaller than A_{high}, wherein the following preferably applies: 0<A_{low}<0.5*A_{high}.

4. The process according to claim 3, wherein the amplitude is set to A_{high} when the product arrives at or before the gap and/or wherein the amplitude is set to A_{low} when the product leaves the gap.

5. The process according to claim 3, wherein a sensor unit is used to detect whether the product is arriving at the gap or leaving the gap, and the sensor unit sends a signal directly to the generator and the generator sets the amplitude to A_{high} or A_{low}, optionally with a time delay.

6. The process according to claim 3, wherein a transition from a current amplitude A_{now} to a target amplitude, in particular A_{high} or A_{low}, is affected by a continuous adaptation (ramp) of the amplitude, wherein a slope of the ramp is preferably controlled continuously and/or wherein the ramp lies within one of the edge regions or overlaps with one of the edge regions.

7. The process according to claim 1, wherein the gap width S is set continuously by moving the sonotrode and/or anvil relative to one another, preferably using a metal contact detection and/or a distance measurement is used as an input variable for controlling the size of the gap and/or a target size for the gap is set and used as an input variable for controlling the gap width S.

8. The process according to claim 1, wherein a plurality of products are moved one after the other through the gap and welded along a welding path in each case.

9. The process according to claim 1, wherein the product is filled with contents before it is moved through the gap and welded, and/or the product is moved through the gap at a speed of 5 m/min to 100 m/min and/or the product comprises at least two layers, preferably with a layer thickness of between 50 μm and 300 μm each.

10. A device for welding a singulated, multi-layer product, comprising:
an ultrasonic tool, which comprises a generator, a converter, a sonotrode and an anvil, wherein a gap with a gap width S is formed between the sonotrode and the anvil, wherein the generator is set up to excite the sonotrode in such a way that it oscillates with an amplitude and wherein the ultrasonic tool is set up to press the sonotrode and/or anvil against the product with a force, wherein at least one welding parameter of the ultrasonic tool, preferably the amplitude and/or the force and/or the gap width, can be controlled and varied, and
a conveying device that is set up to move the singulated product through the gap, preferably to move it in such a way that the product is welded along a welding path by the ultrasonic tool during its movement, by the sonotrode being excited by the generator in such a way that it oscillates with a predetermined amplitude and transmits the vibration to the product.

11. The device according to claim 10, wherein a sensor unit is further provided, which is set up to detect whether the product arrives at or before the gap or whether the product leaves the gap, wherein the sensor unit is preferably connected directly to the generator.

12. The device according to claim 11, wherein the sensor unit comprises at least one sensor, preferably an optical sensor and/or a capacitive sensor, which is oriented such that the product is moved into a detection area of the sensor and/or out of a detection area of the sensor when it arrives at or before the gap and/or when it leaves the gap.

13. The device according to claim 10, wherein the conveying device comprises movable grippers that are each set up to grip one or more products.

14. The device according to claim 10, wherein the sonotrode and/or the anvil has an at least partially circular outer contour and is rotatably mounted.

15. The apparatus according to claim 10, wherein the sonotrode and/or anvil are displaceable relative to one another, wherein preferably a gap control device is electrically connected to a metal contact detection device and/or a sensor is provided for detecting a distance between sonotrode and anvil.

16. The process according to claim 2, wherein the sonotrode for welding the product is excited such that it oscillates with an amplitude A_{high}, wherein A_{high} is preferably between 20 μm and 40 μm, and the sonotrode is excited at other times such that it oscillates with an amplitude A_{low}, which is smaller than A_{high}, wherein the following preferably applies: 0<A_{low}<0.5*A_{high}, wherein the amplitude is set to A_{high} when the product arrives at or before the gap and/or wherein the amplitude is set to A_{low} when the product leaves the gap, and wherein a sensor unit is used to detect whether the product is arriving at the gap or leaving the gap, and the sensor unit sends a signal directly to the generator and the generator sets the amplitude to A_{high} or A_{low}, optionally with a time delay.

17. The process according to claim 16, wherein a transition from a current amplitude A_{now} to a target amplitude, in particular A_{high} or A_{low}, is effected by a continuous adaptation (ramp) of the amplitude, wherein a slope of the ramp is preferably controlled continuously and/or wherein the ramp lies within one of the edge regions or overlaps with one of the edge regions, wherein the gap width S is set continuously by moving the sonotrode and/or anvil relative to one another, preferably using a metal contact detection and/or a distance measurement is used as an input variable for controlling the size of the gap and/or a target size for the gap is set and used as an input variable for controlling the gap width S, wherein a plurality of products are moved one after the other through the gap and welded along a welding path in each case, and wherein the product is filled with contents before it is moved through the gap and welded, and/or the product is moved through the gap at a speed of 5 m/min to 100 m/min and/or the product comprises at least two layers, preferably with a layer thickness of between 50 μm and 300 μm each.

18. The device according to claim 12, wherein the conveying device comprises movable grippers that are each set up to grip one or more products.

19. The device according to claim 18, wherein the sonotrode and/or the anvil has an at least partially circular outer contour and is rotatably mounted.

20. The apparatus according to claim 19, wherein the sonotrode and/or anvil are displaceable relative to one another, wherein preferably a gap control device is electrically connected to a metal contact detection device and/or a sensor is provided for detecting a distance between sonotrode and anvil.
